(19) United States
(12) Patent Application Publication
(10) Pub. No.: US 2003/0006531 A1
(43) Pub. Date: Jan. 9, 2003

(54) Method and tool for forming objects from clay

(76) Inventor: W. Michael Sherrill, Hendersonville, NC (US)

Correspondence Address: Patent Filing Specialist, Inc., 20 Westbridge Dr., Hendersonville, NC, 28739, US

(21) Appl. No.: 10/219,438

(22) Filed: Aug. 14, 2002

Related U.S. Application Data
(63) Continuation-in-part of application No. 09/470,289, filed on Dec. 22, 1999.

(51) Int. Cl. B28B 1/02

(52) U.S. Cl. 264/310

(57) ABSTRACT

Disclosed and described is a tool for forming objects from clay. The tool, commonly referred to as a rib, comprises at least one irregular curved edge and a centrally located hole. The tool also comprises a curved taper region between the hole and the irregular curved edge.

### RELATED APPLICATIONS

This application claims priority to U.S. patent application Ser. No. 09/470,289 filed Dec. 22, 1999 which is pending.

### BACKGROUND

The present invention is directed to a method and tool for forming clay. More specifically the present invention is directed to a method which is particularly useful for forming clay which has been thrown, or is spinning, as commonly done when forming pots and the like.

The art of forming pots from clay has been known for many centuries. One well known technique is to place moldable clay onto a spinning wheel and shaping the spinning clay into an object which has aesthetic appeal or a practical application. The desire to extend the artistry of pots has led to the desire for new tools wherein unique shapes can be imparted in the object. This has led to the development of tools, commonly referred to as ribs, with different shapes and compositions. Most of the commercially available ribs are difficult to use for achieving the desired results due to the design which is rigid. Plastic ribs have been developed in the past yet they have a short life due to the abrasiveness of the clay and they have poor working characteristics due to the inappropriate flexibility and design.

There has been a long standing desire in the art for a rib which is inexpensive, durable and has a flexibility which is suitable for forming shapes in clay.

### SUMMARY

It is an object of the present invention to provide a tool for forming clay which is durable and has a flexibility suitable for use with thrown clay.

It is another object of the present invention to provide a tool for forming clay which is easy to hold and use and which is durable.

These and other objects are provided in a rib for forming objects from clay wherein the rib comprises at least one irregular curved edge and a central region preferably comprising a centrally located hole. The rib also comprises a curved taper region between the central region and the irregular curved edge and an optional land between the central region and the curved taper region.

A preferred embodiment of the present invention is provided in a tool for forming objects. The tool comprises at least one irregular curved edge and a centrally located hole. The tool comprises a polyurethane with a stiffness of at least 30 D to no more than 80 D.

Yet another embodiment of the present invention is provided in a tool for forming objects wherein the tool comprises at least one irregular curved edge; at least one straight edge; and a centrally located hole. The tool also comprises a curved taper region between the hole and the irregular curved edge and the curved taper region circumvents the hole.

A particular preferred embodiment is provided in a method for forming objects from clay. The object comprises the steps of throwing clay to form a preliminary object. The clay is then contacted with a rib. The rib comprises at least one edge comprising an irregular curved shape. The rib also comprise a central region. The rib comprises a curved taper region between the central region and the irregular curved edge. The method further comprise imparting the irregular curved shape into the preliminary object to form a secondary object.

Yet another preferred embodiment is provided in a method for forming objects from clay. The method comprise throwing the clay to form a preliminary clay object. The preliminary clay object is then contacted with a tool. The tool comprises at least one irregular curved edge, a centrally located hole and a curved taper region between the hole and the irregular curved edge. The tool comprises a polyurethane with a stiffness of at least 30 D to no more than 80 D. The method further comprises imparting an impression of the irregular curved edge on the preliminary clay object.

Yet another preferred embodiment is provided in a method for forming clay objects. The method comprises the steps of throwing the clay to form a preliminary clay object. The preliminary clay object is then spun forming a rotating clay object. The rotating clay object is contacted with a tool. The tool comprises at least one irregular curved edge, at least one straight edge and a centrally located hole. The tool also comprises a curved taper region between the hole and the irregular curved edge circumventing the hole. The tool imparts an impression of at least one shape selected from the irregular curved edge and the straight edge in the rotating clay object.

### BRIEF DESCRIPTION OF DRAWINGS

FIG. 1 is a perspective view of an embodiment of the present invention.

FIGS. 2 and 3 are perspective view of alternate embodiments of the present invention.

FIG. 4 is a cross-cut perspective view of an embodiment of the present invention.

FIG. 5 is a cross-sectional view taken along line 5-5 of FIG. 4.

### DETAILED DESCRIPTION

Throughout the following description similar elements are numbered accordingly.

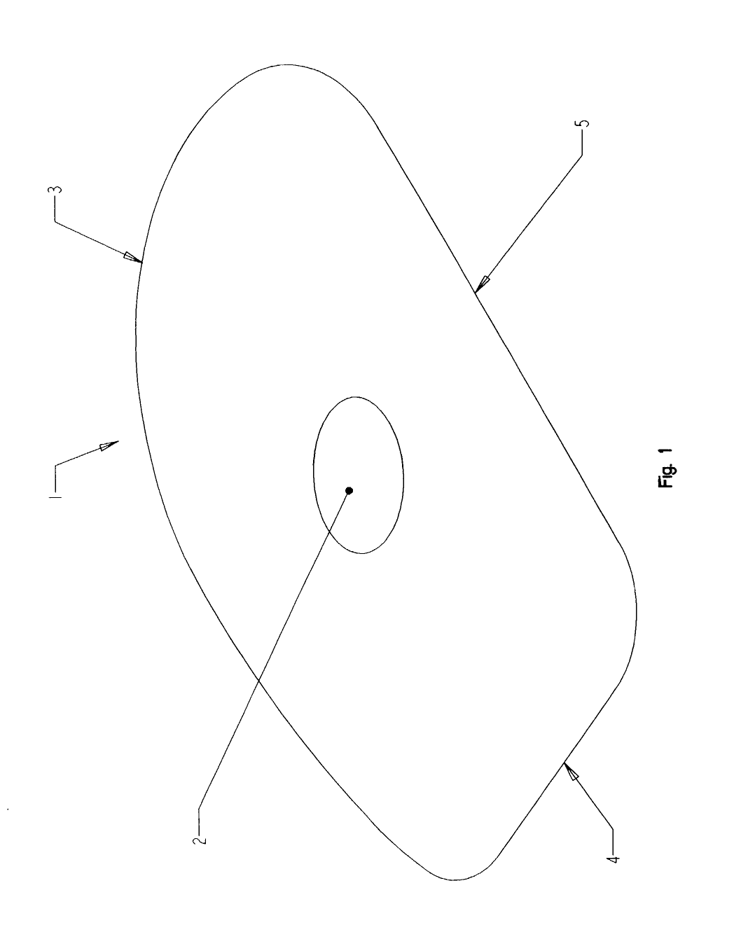

FIG. 1 illustrates an embodiment of a clay tool, or rib, of the present invention. The clay tool, generally represented at 1, comprises a central region with an optional, but preferred, centrally located hole, 2, within the central region which aids in the handling of the clay tool. The central region is chosen to be the center of gravity, or balance point, of the clay tool and is preferably no more than 3 cm long in any direction. The hole, 2, is preferably elliptical to restrict rotation of the clay tool around the axis of the hole during use. The size of the hole is chosen such that an artisan can easily hold the clay tool between the thumb and a finger and have the thumb and finger in contact with each other and with the surface of the clay tool at the same time. This insures optimum control of the clay tool during use. In practice, the preferred size of the hole has been determined to be at least 0.5 cm to no more than 2 cm. More preferred, is an ellipse wherein both the short axis and the long axis are at least 0.5 cm and no more than 2 cm. Particularly preferred is an elliptical hole with a short axis of at least 0.5 cm to no more than 1.5 cm and a long axis of at least 0.7 cm to no more than 2 cm. Most preferred is an elliptical hole with a short axis of at least 0.75 cm to no more than 1.25 cm and a long axis of at least 1.0 cm to no more that 1.75 cm.

The term “centrally located” in reference to the hole means the hole is in the central region and does not breech the edge of the tool. Preferably, the centrally located hole is located such that the tool is balanced at the axis of the hole. This improves the ability of the artisan to handle the tool.

The general shape of the embodiment illustrated in FIG. 1 can be described as a rounded rectangular wafer with a first straight edge, 4, and a second straight edge, 5, approximately perpendicular to the first straight edge, 4, and an irregular curved edge, 3, forming the rounded edges of the rounded rectangle. For the purposes of the present invention the term “irregular curved edge” refers to a shape wherein the radius of curvature at consecutive spaced tangents to the shape vary similar to that observed in a french curve as used in drafting.

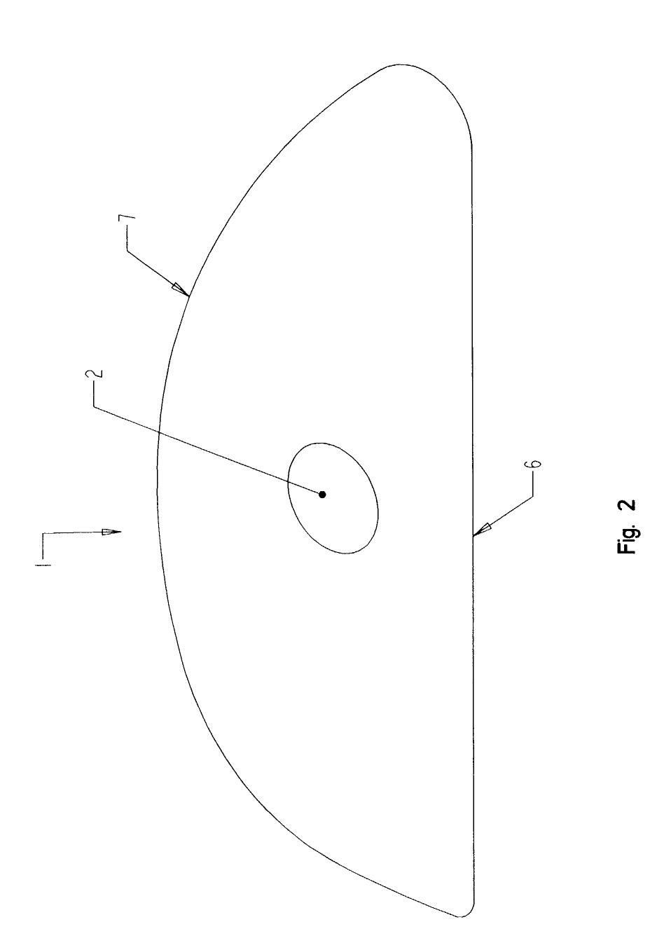

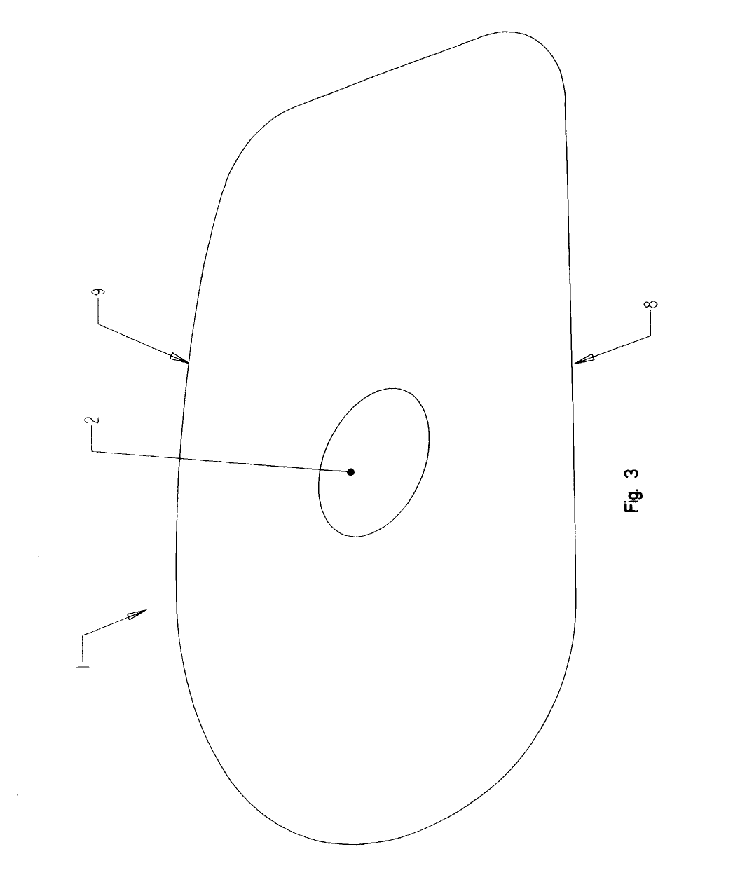

FIGS. 2 and 3 illustrate other embodiments of the present invention wherein other projected shapes are shown. In FIG. 2 a single straight edge, 6 is provided on one side of the clay tool, 1, and an irregular curved edge, 7, defines the shape of the other sides of the clay tool. In FIG. 3 a minimal straight edge, 8, is provided and the other sides of the clay tool, 1, are defined by an irregular curved edge, 9.

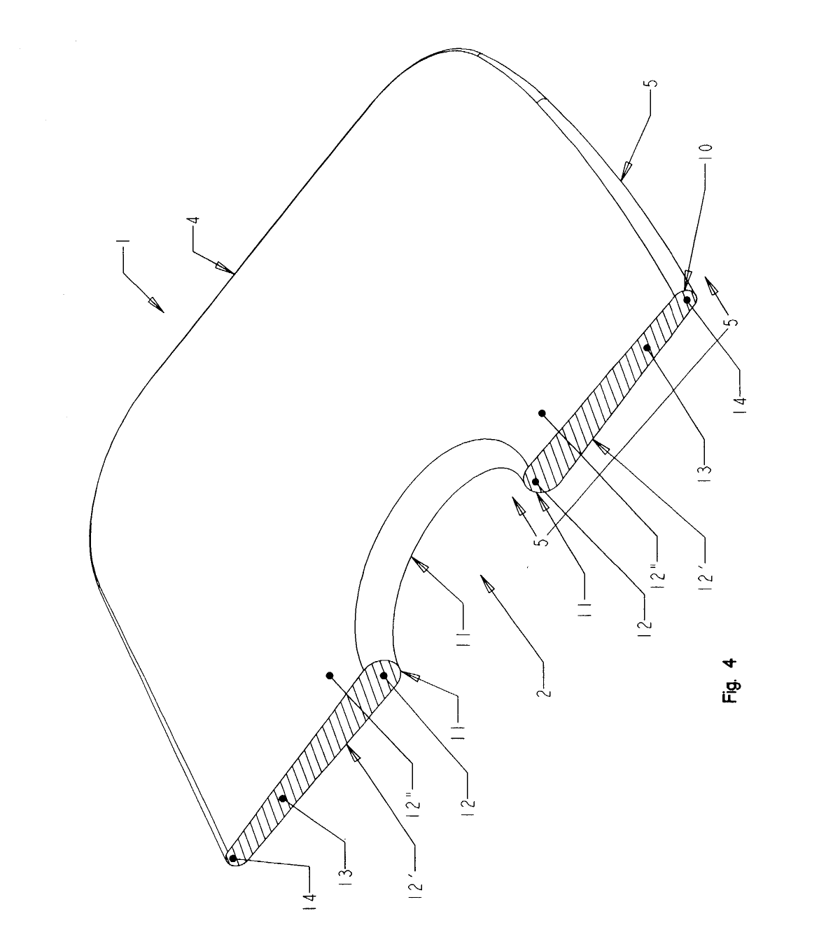

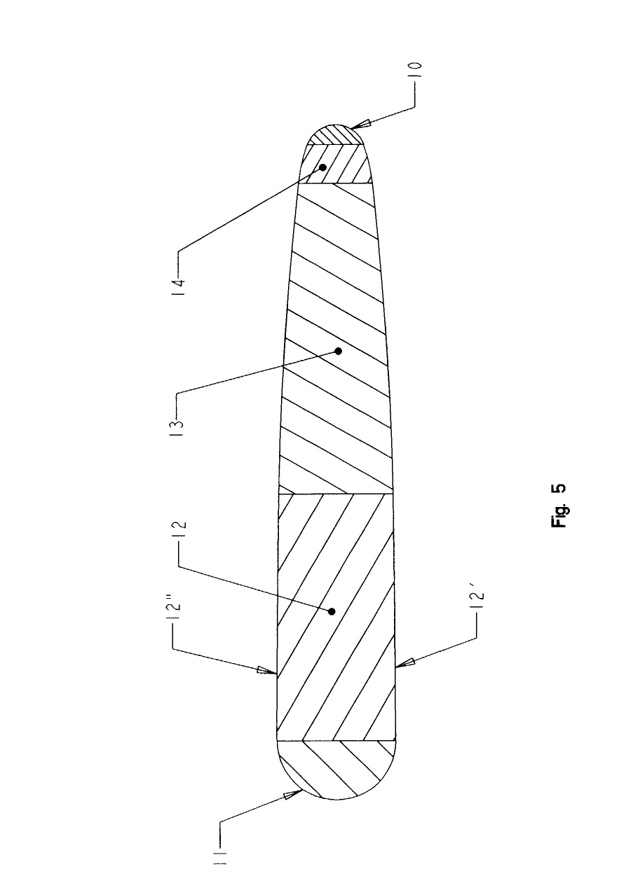

The cross-sectional shape of the present invention is more readily described in reference to FIGS. 4 and 5.

A cross-cut perspective view of an embodiment of the present invention is provided in FIG. 4. A cross-sectional view taken along 5-5 of FIG. 4 is provided in FIG. 5. The clay tool is best described in relation to five regions between the hole, 2, to the edge, 10. The hole, 2, is bound by a hole edge, 11. The hole edge is preferably an arc. The arc has a radius of curvature which is at least as large as the thickness of a land, 12, which will be described further. Attached to the hole edge, 11, is a preferred but optional land, 12. The land is defined by an upper land surface 12′, and a lower land surface, 12″. The upper land surface and lower land surface are preferably parallel. The land represents the thickest portion of the clay tool and preferably circumvents the hole. The length of the land is preferably no more than 1.5 cm and more preferably no more than 1 cm. Most preferred is a clay tool with a land length of no more than 0.5 cm. The thickness of the land is preferably at least 1 mm and no more than 8 mm. More preferred is a land thickness of at least 2 mm and no more than 6 mm. Most preferred is a land thickness of at least 3 mm and no more than 5 mm. Exterior to the optional land is a curved taper region comprising at least one curved taper section. The curved taper region preferably circumvents the land, if present, and the central region. More preferably the curved taper region comprise a first curved taper section, 13, and exterior thereto a second curved taper section, 14. Preferably, the second curved taper section circumvents the first curved taper section. When multiple curved taper sections are provided it is most preferable that each subsequent curved taper section has a smaller initial curvature of radius than the final curvature of radius of the curved taper section immediately interior thereto. Exterior to the curved taper section is the terminus, 10. The terminus is an arc with a radius of curvature at least as large as the thickness of the most exterior curved taper section at its intersection with the terminus.

The central region is that region interior to the land, or in the absence of a land, that region interior to the curved taper region.

For the purposes of the present invention the term “curved taper” refers to a taper which has a continuously decreasing radius of curvature from the thickest end to the thinnest end such that at any given point along the curved taper the thickness is no less than the thickness that would be expected for a linear taper. A linear taper is one in which the upper and lower surface of a taper are both planar from the thickest end of the taper to the thinnest end of the taper.

The length of the first curved taper region is preferably at least approximately 0.5 cm to no more than approximately 8 cm. More preferably, the length of the first curved taper region is preferably at least approximately 0.75 cm to no more than approximately 5 cm and most preferably the length of the first curved taper region is at least approximately 1 cm to no more than approximately 4.5 cm.

The length of the second curved taper region is preferably no more than approximately 1 cm. More preferably, the length of the second curved taper region is no more than approximately 0.5 cm and most preferably the length of the second curved taper region is no more than approximately 0.15 cm.

The thickness of the curved taper section at its intersection with the terminus is preferable at least approximately 1 mm to no more than approximately 10 mm. More preferably the thickness of the curved taper section at its intersection with the terminus is at least 2 mm to no more than 8 mm and most preferably at least 4 mm to no more than 6 mm.

The clay tool of the present invention is preferably manufactured from a plastic. Most preferably, the plastic is a polyurethane due to the durability over extended periods of use. Polyurethanes have been found to be particularly durable when used as a clay tool since the minerals and solutions typically encountered when working with clay have minimal impact on the brittleness of polyurethanes. Therefore, a clay tool manufactured from polyurethanes has a longer useful life than many other materials.

The stiffness of the clay tool, in part, determines the ease with which certain shapes can be obtained. If the clay tool is to stiff the clay does not ablate cleanly and voids may be created in the object being formed. If the clay tool is to soft then the shape of the tool is not imparted on the object being formed since no clay is ablated. It has been determined that the preferred clay tool is manufactured from a polymer with a Shore D hardness of at least 30 D to no more than 80 D as determined by ASTM test method D 2240 wherein the units are Durometer (D) with a higher durometer indicating a stiffer polymer. More preferably, the clay tool is manufactured from a polymer with a Shore D hardness of at least 40 D to no more than 76 D. Particularly preferred are polyurethanes with a Shore D hardness of at least 30 D to no more than 80 D.

Polyurethane Polymers which have been found to be of particular utility in the present invention are provided in the Table. These are provided as representative and do not limit the scope of the present invention. Other polymers, and other polyurethane polymers, could be used without departing from the scope of the present invention.

TABLE
Representative Polyurethane Polymers

| Polymer | Vendor | Shore D |
|---|---|---|
| Pellethane 2103-75D | The Dow Chemical | 76 D |
| | Company | |
| Texin 260 | Bayer Corporation | 60 D |
| Texin 255 | Bayer Corporation | 55 D |
| Texin 245 | Bayer Corporation | 45 D |
| Desmopan KU2-8651 | Miles, Inc. | 76 D |
| Desmopan 445 | Bayer Corporation | 45 D |
| Texin 4210 | Bayer Corporation | 70 D |

The process of manufacture for the present invention can be easily envisioned by one skilled in the art to include most common methods of polymer forming. Included are molding, extruding and the like. The field of forming materials from plastics is well known in the art and further elaboration is not necessary to fully disclose the present invention.

The invention has been described in such a manner that a skilled artisan could utilize the present invention without undue experimentation. The examples and specific preferred embodiments have been included for clarity and are not intended to limit the scope of the invention.

Claimed is:

1. A method for forming objects from clay comprising the steps of:
a) throwing said clay to form a preliminary object;
b) contacting said clay with a rib wherein said rib comprises:
at least one edge comprising an irregular curved shape and a central region; and
wherein said rib comprises a curved taper region between said central region and said irregular curved edge; and
c) imparting said irregular curved shape into said preliminary object to form a secondary object.

2. The method of claim 1 wherein said rib further comprises a centrally located hole located within said central region.

3. The method of claim 2 wherein said hole is elliptical with a long axis and a short axis.

4. The method of claim 3 wherein said long axis is at least 0.5 cm to no more than 2 cm.

5. The method of claim 1 wherein said rib further comprises a land between said hole and said irregular curved edge.

6. The method of claim 5 wherein said land has a length of no more than 1.5 cm.

7. The method of claim 5 wherein said land has a thickness of at least 1 mm to no more than 8 mm.

8. The method of claim 1 wherein said curved taper region has a length of at least 0.5 cm to no more than 9 cm.

9. The method of claim 1 wherein said curved taper region comprises a first curved taper section and a second curved taper section exterior to said first curved taper section.

10. The method of claim 1 wherein said rib comprises a polymer with a stiffness of at least 30 D to no more than 80 D.

11. The method of claim 10 wherein said stiffness is at least 40 D to no more than 76 D.

12. The method of claim 1 wherein said rib comprises a polyurethane.

13. The method of claim 1 further comprising, prior to said contacting;
spinning said preliminary object.

14. A method for forming objects from clay comprising:
a) throwing said clay to form a preliminary clay object;
b)contacting said preliminary clay object with a tool comprising:
at least one irregular curved edge and a centrally located hole and a curved taper region between said hole and said irregular curved edge;
and said tool comprises a polyurethane with a stiffness of at least 30 D to no more than 80 D; and
c) imparting an impression of said irregular curved edge on said preliminary clay object.

15. The method of claim 14 further comprising spinning said preliminary clay object prior to said contracting.

16. A method for forming clay objects comprising the steps of:
a)throwing said clay to form a preliminary clay object;
b)spinning said clay to from a rotating clay object;
c) contacting said rotating clay object with a tool wherein said tool comprises:
at least one irregular curved edge;
at least one straight edge;
a centrally located hole;
a curved taper region between said hole and said irregular curved edge and circumventing said hole; and
imparting an impression of at least one shape selected from said irregular curved edge and said straight edge in said rotating clay object.

17. The method of claim 16 further comprising a land between said hole and said curved taper region and wherein said land circumvents said hole.

18. The method of claim 17 wherein said curved taper region circumvents said land.
